(19) United States
(12) Patent Application Publication
(10) Pub. No.: US 2020/0377072 A1
(43) Pub. Date: Dec. 3, 2020

(54) METHOD AND APPARATUS TO CONTROL OPERATION OF A VEHICLE

(71) Applicant: GM GLOBAL TECHNOLOGY OPERATIONS LLC, Detroit, MI (US)

(72) Inventors: Kee Y. Kim, Ann Arbor, MI (US); Anthony H. Heap, Ann Arbor, MI (US); Michael A. Miller, Fenton, MI (US); Birendra P. Bhattarai, Redondo Beach, CA (US); Joshua F. Pacheco, Berkley, MI (US)

(73) Assignee: GM GLOBAL TECHNOLOGY OPERATIONS LLC, Detroit, MI (US)

(21) Appl. No.: 16/423,603

(22) Filed: May 28, 2019

(51) Int. Cl. B60W 20/00; B60W 30/18

(52) U.S. Cl. CPC B60W 20/00; B60K 6/28; B60W 2510/244; B60W 30/18127

(57) ABSTRACT

A powertrain system is described and includes an internal combustion engine that is coupled to an electric machine that is electrically connected to a DC power source, and a controller. The controller is operatively connected to the internal combustion engine and the electric machine, and is in communication with the vehicle and the DC power source. Control includes dynamically monitoring vehicle speed and a state of charge (SOC) of the DC power source, and transitioning to operating the electric machine in an alternator emulating mode when the SOC is less than a first SOC threshold. The first SOC threshold is determined based upon the vehicle speed. The DC power source is electrically connected to an on-vehicle auxiliary power system, which includes operating the electric machine in an electric power generating state to generate sufficient electric power to service the auxiliary power system.

### INTRODUCTION

Hybrid powertrain systems employ on-vehicle generate tractive power from multiple sources, including, e.g., an internal combustion engine and an electric machine, with one outcome being to reduce or minimize power consumption from fuel and an second energy source such as an electric DC power source.

Certain hybrid powertrain systems operate in a charge sustaining mode, wherein an operational goal is to have a state of charge (SOC) of a DC power source be unchanged at the end of a trip as compared to a beginning of the trip. This charge sustaining mode may further include having the SOC of the DC power source be unchanged at the end of a segment of a trip as compared to a beginning of the segment of the trip. During operation in the charge sustaining mode, the vehicle may consume electric power during selected portions of a trip segment and generate electric power during other selected portions of the trip segment in order to achieve an unchanged SOC at the end of the trip segment.

Powertrain operating modes associated with SOC and operational control of the electric machine may include an opportunity charging mode, an opportunity discharging mode, a zero-motor torque mode and a regenerative braking mode.

There may be benefit to operating the electric machine in an alternator emulating mode during a trip segment in order to better manage SOC in the DC power source, SOC generation by the electric machine. Such benefits include, e.g., stabilization of SOC control between opportunity charging and opportunity discharging, fuel economy benefits by providing a direct control of opportunity charging, and improvements in NVH by reducing the quantity of transitions between opportunity charging and opportunity discharging.

### SUMMARY

A powertrain system for a vehicle, and an associated method are described. The powertrain system includes an internal combustion engine that is coupled to an electric machine that is electrically connected to a DC power source, and a controller. The controller is operatively connected to the internal combustion engine and the electric machine, and is in communication with the vehicle and the DC power source. The controller includes an instruction set that is executable to dynamically monitor vehicle speed and a state of charge (SOC) of the DC power source, and transition to operating the electric machine in an alternator emulating mode when the SOC is less than a first SOC threshold. The first SOC threshold is determined based upon the vehicle speed. The DC power source is electrically connected to an on-vehicle auxiliary power system, which includes operating the electric machine in an electric power generating state to generate sufficient electric power to service the auxiliary power system.

An aspect of the disclosure includes operating the electric machine in the electric power generating state, wherein operation in the electric power generating state is limited to generate electric power to service on-board accessory devices via the auxiliary power system.

Another aspect of the disclosure includes operating the electric machine in the alternator emulating mode including operating the electric machine in the electric power generating state to generate sufficient electric power to service on-board accessory devices via the auxiliary power system and limited to avoid increasing the SOC of the DC power source.

Another aspect of the disclosure includes operating the electric machine in the alternator emulating mode, including operating the electric machine in the electric power generating state to generate sufficient electric power to service the auxiliary power system to provide low-voltage electric power to low-voltage on-vehicle systems.

Another aspect of the disclosure includes the first SOC threshold being determined based upon the vehicle speed.

Another aspect of the disclosure includes the first SOC threshold being determined based upon the vehicle speed and a desired final SOC.

Another aspect of the disclosure includes the first SOC threshold being determined based upon a predicted increase in SOC that is expected to be achieved during operation in a regenerative braking mode.

Another aspect of the disclosure includes the controller being arranged to control the internal combustion engine and the electric machine to manage the DC power source in a charge sustaining state.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically shows a vehicle including a powertrain system coupled to a driveline, and a HV battery, all of which are controlled by a control system, in accordance with the disclosure.

FIG. 2 schematically shows a plurality of powertrain operating modes associated with different SOC control modes, wherein the powertrain operating mode is indicated in relation to SOC of the HV battery in accordance with the disclosure.

FIG. 3 schematically shows a state diagram associated with selecting one of the powertrain operating modes associated with SOC control in accordance with the disclosure.

FIG. 4 graphically shows results associated with operation of an embodiment of the vehicle including the powertrain system described with reference to FIG. 1, including operating in accordance with the state diagram associated with selecting one of the powertrain operating modes associated with SOC control that is described with reference to FIG. 3, in accordance with the disclosure.

It should be understood that the appended drawings are not necessarily to scale, and present a somewhat simplified representation of various features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the drawings are in simplified form and are not to precise scale. For purposes of convenience and clarity, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

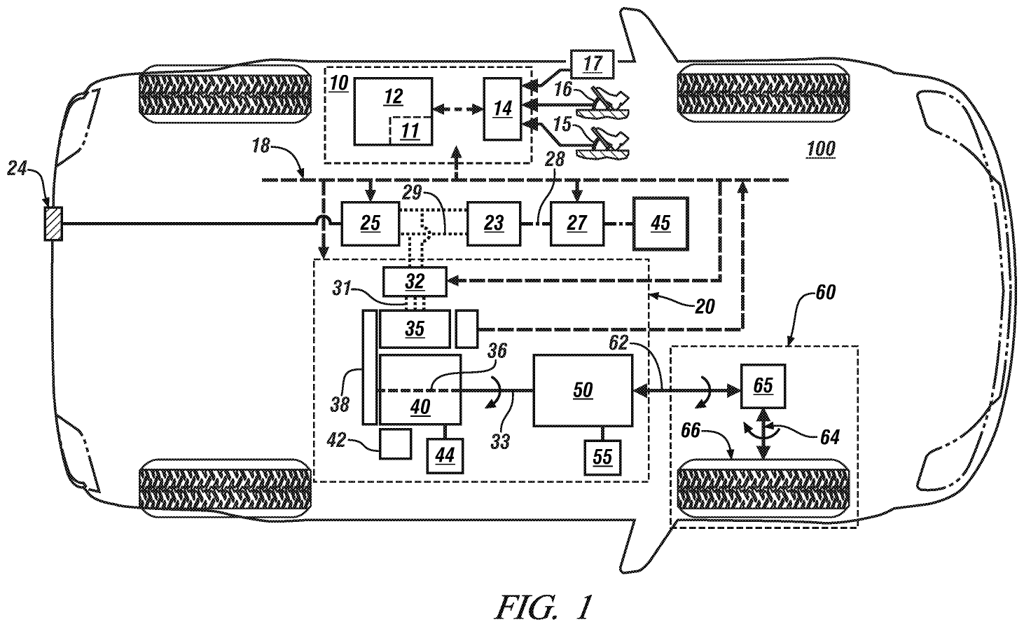

Referring now to the drawings, wherein the showings are for the purpose of illustrating certain exemplary embodiments and not for the purpose of limiting the same, FIG. 1 schematically shows a vehicle 100 including a powertrain system 20 coupled to a driveline 60 and controlled by a control system 10. Like numerals refer to like elements throughout the description. The illustrated powertrain system 20 includes multiple torque-generating devices including an internal combustion engine 40 and at least one electrically-powered electric machine (electric machine) 35 that transfer torque through a transmission 50 to a driveline 60. The concepts described herein may apply to powertrain configurations that include the internal combustion engine 40 coupled to the driveline 60 via the transmission 50. The vehicle may include, but not be limited to a mobile platform in the form of a commercial vehicle, industrial vehicle, agricultural vehicle, passenger vehicle, aircraft, watercraft, train, all-terrain vehicle, personal movement apparatus, robot and the like to accomplish the purposes of this disclosure.

In one embodiment, the powertrain system 20 includes the electric machine 35 rotatably mechanically coupled to a crankshaft 36 of the engine 40 that rotatably mechanically couples to an input member 33 of the transmission 50. The mechanical coupling may include a torque converter, a clutch, or another mechanism. As shown, the crankshaft 36 mechanically rotatably couples to the electric machine 35 via a pulley mechanism 38. The pulley mechanism 38 is configured to effect torque transfer between the engine 40 and the electric machine 35, including transferring torque from the electric machine 35 to the engine 40 for engine autostart and autostop operations, tractive torque assistance, torque transfer for regenerative vehicle braking, and torque transfer from engine 40 to the electric machine 35 for high-voltage electrical charging. In one embodiment, the pulley mechanism 38 includes a serpentine belt routed between a first pulley attached to the crankshaft 36 of the engine 40 and a second pulley attached to a rotating shaft coupled to a rotor of the electric machine 35, referred to as a belt-alternator-starter (BAS) system. Alternatively, the pulley mechanism 38 may include a positive-displacement gearing mechanism, or another suitable positive mechanical connection. As such, the electric machine 35 can be employed to rotate the engine 40. Other configurations of the multi-mode powertrain system 20 that include the electric machine 35 rotatably mechanically coupled to the engine 40 may be employed within the scope of this disclosure.

The engine 40 is a multi-cylinder internal combustion engine that converts fuel to mechanical torque through a thermodynamic combustion process. The engine 40 is equipped with a plurality of actuators and sensing devices for monitoring operation and delivering fuel to form in-cylinder combustion charges that generate an expansion force onto pistons that is transferred to the crankshaft 36 to produce torque. The engine 40 may include a low-voltage solenoid-actuated electrical starter 42 for engine starting in response to a key-crank event in one embodiment.

The engine 40 is controlled by an engine controller (ECM) 44, including controlling engine operation in one or more various states including, an ON state, an OFF state, an all-cylinder state, a cylinder deactivation state, a fueled state and a fuel cutoff (FCO) state. The engine 40 is mechanized with suitable hardware and the ECM 44 includes control routines to execute autostart and autostop functions, fuel cutoff (FCO) functions and cylinder deactivation functions during ongoing operation of the powertrain system 20. The engine 40 is considered to be in an OFF state when it is not rotating. The engine 40 is considered to be in an ON state when it is rotating, including one or more FCO states in which the engine 40 is spinning and unfueled. The cylinder deactivation state includes engine operation wherein one or a plurality of the engine cylinders are deactivated by unfueled, unfired, and may include operating with engine exhaust valves in open states to minimize pumping losses, while remaining cylinders are fueled, firing and producing torque. Engine mechanizations and control routines for executing autostart, autostop, FCO and cylinder deactivation routines are understood by skilled practitioners, and not described herein.

One exemplary transmission 50 is a multi-ratio fixed-gear torque transmission device that is configured to automatically shift gears at predetermined speed/torque shift points. The transmission 50 is configured to operate in one of a plurality of selectable fixed-gear ratios that achieves a match between an operator torque request and an engine operating point, and may include employing one or a plurality of differential gear sets and hydraulically-activated clutches to effect gear shifting to permit torque transfer in one of the selectable fixed gear ratios over a range of speed ratios between the input member 33 and output member 62. The transmission 50 may be controlled using a controllable hydraulic circuit that communicates with a transmission controller (TCM) 55. The transmission 50 executes upshifts to shift to a fixed gear that has a lower numerical multiplication ratio (gear ratio) and executes downshifts to shift to a fixed gear that has a higher numerical multiplication ratio. A transmission upshift may require a reduction in engine speed so the engine speed matches transmission output speed multiplied by the gear ratio at a gear ratio associated with a target gear state. A transmission downshift may require an increase in engine speed so the engine speed matches transmission output speed multiplied by the gear ratio at a gear ratio associated with the target gear state.

The electric machine 35 may be a high-voltage multi-phase electric motor/generator configured to convert stored electric energy to mechanical power and convert mechanical power to electric energy that may be stored in a high-voltage DC power source (HV battery) 25. The HV battery 25 may be a high-voltage energy storage device, e.g., a multi-cell lithium ion device, an ultra-capacitor, or another device without limitation. Monitored parameters related to the HV battery 25 may include a state of charge (SOC), temperature, and others. In one embodiment, the HV battery 25 may electrically connect via an on-vehicle battery charger 24 to a remote, off-vehicle electric power source for charging while the vehicle 100 is stationary. The HV battery 25 electrically connects to an inverter module 32 via a HV DC electric power bus 29 to transfer high-voltage DC electric power via three-phase conductors 31 to the electric machine 35 in response to control signals originating in the control system 10.

The electric machine 35 includes a rotor and a stator, and electrically connects via the inverter module 32 and the HV DC electric power bus 29 to the HV battery 25. The inverter module 32 is configured with control circuits including power transistors, e.g., IGBTs for transforming high-voltage DC electric power to high-voltage AC electric power and transforming high-voltage AC electric power to high-voltage DC electric power. The inverter module 32 employs pulsewidth-modulating (PWM) control of the IGBTs to convert stored DC electric power originating in the HV battery 25 to AC electric power to drive the electric machine 35 to generate torque. Similarly, the inverter module 32 converts mechanical power transferred to the electric machine 35 to DC electric power to generate electric energy that is storable in the HV battery 25, including as part of a regenerative control strategy. The inverter module 32 receives motor control commands and controls inverter states to provide the motor drive and regenerative braking functionality. In one embodiment, a DC/DC electric power converter 23 electrically connects to the HV DC electric power bus 29, and provides electric power to a low-voltage battery 27 via a low-voltage bus 28. The low-voltage battery 27 electrically connects to an auxiliary power system 45 to provide low-voltage electric power to low-voltage systems on the vehicle, including, e.g., electric windows, HVAC fans, seats, and the low-voltage solenoid-actuated electrical starter 42.

The driveline 60 may include a differential gear device 65 that mechanically couples to an axle 64, transaxle or half-shaft that mechanically couples to a wheel 66 in one embodiment. The driveline 60 transfers tractive power between the transmission 50 and a road surface.

The control system 10 includes controller 12 that signally connects to an operator interface 14. The controller 12 includes a plurality of discrete devices that are co-located with the individual elements of the powertrain system 20 to effect operational control of the individual elements of the powertrain system 20, including, e.g., the inverter module 32, the ECM 44 and the TCM 55. The controller 12 may also include a control device that provides hierarchical control of other control devices. The controller 12 communicates with each of the battery charger 24, the inverter module 32, the ECM 44 and the TCM 55, either directly or via a communication bus 18 to monitor operation and control operations thereof.

The operator interface 14 of the vehicle 100 includes a controller that signally connects to a plurality of human/machine interface devices through which the vehicle operator commands operation of the vehicle 100. The human/machine interface devices include, e.g., an accelerator pedal 15, a brake pedal 16 and a transmission range selector (PRNDL) 17. Other human/machine interface devices may include an ignition switch to enable an operator to crank and start the engine 40, a steering wheel, and a headlamp switch. Other human/machine interface devices may include a cruise control actuator and an adaptive cruise control actuator. Other systems through which operation of the vehicle 100 may be commanded may include autonomous vehicle controls such as a collision avoidance system. The accelerator pedal 15 provides signal input indicating an accelerator pedal position and the brake pedal 16 provides signal input indicating a brake pedal position, both of which are monitored to determine an output torque request. The transmission range selector 17 provides signal input indicating direction of operator-intended motion of the vehicle including a discrete number of operator-selectable positions indicating the desired rotational direction of the output member 62 in either a forward or a reverse direction. The accelerator pedal 15, brake pedal 16, transmission range selector (PRNDL) 17, the cruise control system and the autonomous control systems (not shown) are employed to generate an output torque request, which is used to command operation of the powertrain system 20 and the vehicle braking system to effect vehicle acceleration and deceleration.

The terms controller, control module, module, control, control unit, processor and similar terms refer to one or various combinations of Application Specific Integrated Circuit(s) (ASIC), electronic circuit(s), central processing unit(s), e.g., microprocessor(s) and associated non-transitory memory component 11 in the form of memory and storage devices (read only, programmable read only, random access, hard drive, etc.). The non-transitory memory component 11 is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions, including monitoring inputs from sensing devices and other networked controllers and executing control and diagnostic routines to control operation of actuators. Routines may be executed at regular intervals, for example each 100 microseconds, during ongoing operation. Alternatively, routines may be executed in response to occurrence of a triggering event. Communication between controllers and between controllers, actuators and/or sensors may be accomplished using a direct wired link, a networked communication bus link, a wireless link, a serial peripheral interface bus or another communication link. Communication includes exchanging data signals, including, for example, electrical signals via a conductive medium, electromagnetic signals via air, optical signals via optical waveguides, and the like. Data signals may include signals representing inputs from sensors, signals representing actuator commands, and communication signals between controllers. As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine.

Vehicle operation responsive to the output torque request includes operating modes of accelerating, braking, steady-state running, coasting, and idling. The acceleration mode includes an output torque request to increase vehicle speed. The braking mode includes an output torque request to decrease vehicle speed. The steady-state running, includes vehicle operation wherein the vehicle is presently moving at a rate of speed with no request for either braking or accelerating, with the vehicle speed determined based upon the present vehicle speed and vehicle momentum, vehicle wind resistance and rolling resistance, and driveline inertial drag. The coasting mode includes vehicle operation wherein vehicle speed is above a minimum threshold and the output torque request is at a point that is less than required to maintain the present vehicle speed. The idle mode includes vehicle operation wherein vehicle speed is at or near zero with the transmission range selector in a non-propulsion range, or in one of the propulsion ranges with the output torque request including zero input to the accelerator pedal and minimal or slight input to the brake pedal.

Engine operation may be described in context of several control variables, including engine operation state, engine fueling state, and engine cylinder state. The engine operation control variable includes either the ON or OFF state. The engine fueling control variable includes either the fueled state or the FCO state. The engine cylinder control variable includes either the all-cylinder state or the cylinder deactivation state. Transmission operation may be described in context of a control variable related to a selected fixed gear state. In one embodiment, transmission operation may be described in context of a control variable related to one of a fixed gear mode, a continuously-variable mode or an electrically-variable mode, depending upon the specific configuration of the transmission.

Operation of an embodiment of the powertrain system 20 described with reference to FIG. 1 includes changing one of the control variables to optimize operation, including changing a control variable to reduce power loss, to reduce power consumption, and improve performance. As such, a control variable may change in response to a change in an operating condition, including by way of example an input from the vehicle operator, an input related to external operating conditions, or an input related to operation of the powertrain system 20. Monitored inputs from the vehicle operator may include inputs communicated via the accelerator pedal 15 or the brake pedal 16. Monitored inputs related to operating conditions include inputs related to a change in road load, such as beginning to operate on an inclined road surface. Monitored inputs related to operation of the powertrain system 20 may include, for example, a change in SOC of the HV battery 25 or a system fault.

A change in a control variable, e.g., a change between engine ON and OFF states or a change between fixed transmission gear ratios, may include some hysteresis to minimize state transitions that may lead to operator dissatisfaction and/or affect service life of one or more components such as electric starter motors and the like. However, continued operation within a hysteresis window at a non-optimal state may increase power consumption.

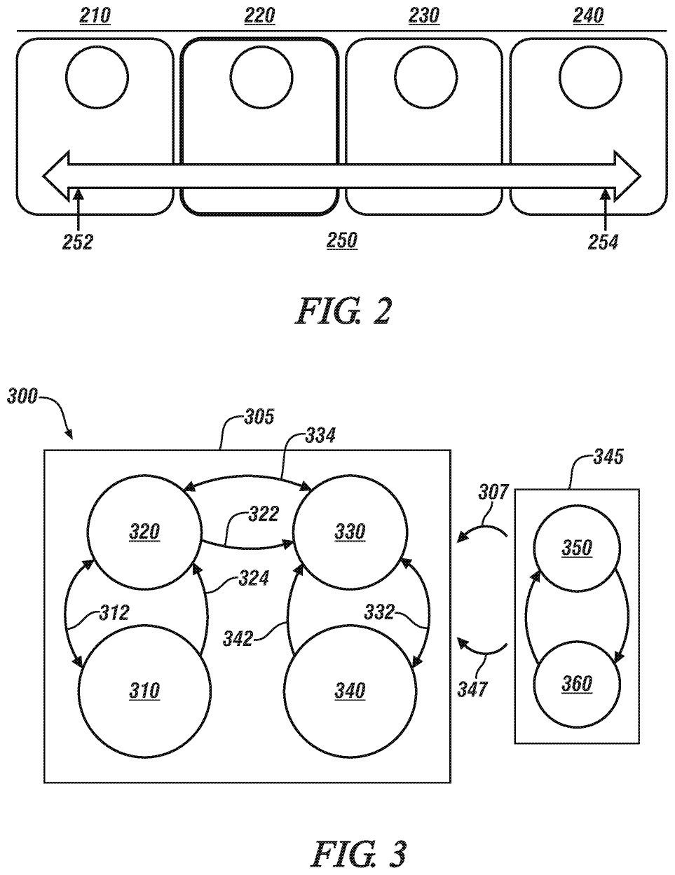

FIG. 2, with continued reference to FIG. 1, schematically shows a plurality of powertrain operating modes associated with different SOC control modes for an embodiment of the vehicle 100 and powertrain system 20 of FIG. 1. The powertrain operating modes include controlling operation of the electric machine 35 in one of an opportunity charging mode 210, an alternator emulating mode 220, a zero-motor-torque (ZMT) mode 230, and an opportunity discharging mode 240, wherein the selection of the operating mode is determined in relation to SOC of the HV battery 25 250. The SOC of the HV battery 25 250 ranges between a minimum SOC state 252 and a maximum SOC state 254

The opportunity charging mode 210 is a powertrain operating mode in which the internal combustion engine 40 is operated and fuel is consumed to generate electric power to charge the HV battery 25 via the electric machine 35, which is operating in an electric power generating state. The opportunity charging mode is activated when the SOC of the HV battery 25 is at or near a minimum value. The opportunity charging mode is inefficient as compared to regenerative braking charging because fuel is expended to operate in the opportunity charging mode, whereas regenerative braking charging captures vehicle kinetic energy without expending fuel.

The opportunity discharging mode 240 is a powertrain operating mode in which electric power from the HV battery 25 is employed to generate tractive torque via the electric machine 35, which is operating in a torque generating state and thus is displacing operation of the internal combustion engine 40. The opportunity discharging mode is activated when the SOC of the HV battery 25 is at or near a maximum value.

The ZMT mode 230 is a powertrain operating mode in which the electric machine 35 is decoupled from the internal combustion engine 40 via an intermediate clutch (not shown), or when the electric machine 35 is not operating by having the inverter module 32 deactivate switching of the IGBTs, thus reducing drag and improving efficiency of the inverter.

The alternator emulating mode 220 is a powertrain operating mode in which the electric machine 35 is operating in an electric power generating state to generate electric power to supply electric power to the auxiliary power system 45, which provides low-voltage electric power to the low-voltage systems on the vehicle 100, including, e.g., electric windows, HVAC fans, seats, etc. Furthermore, there is no intentional charging or discharging of the HV battery 25 in the alternator emulating mode 220. Instead, when the electric machine 35 is operating in the alternator emulating mode 220 to generate electric power, such operation is limited to generate electric power that is sufficient to service the on-board accessory devices via the auxiliary power system 45, and limited to avoid or preclude increasing the SOC of the HV battery 25. This includes operating the electric machine 35 in the electric power generating state at a level that is sufficient to generate sufficient electric power to service on-board accessory devices via the auxiliary power system 45, including operating the electric machine 35 in the electric power generating state to generate sufficient electric power to service on-board accessory devices via the auxiliary power system 45 while maintaining the SOC of the HV battery 25 at the SOC threshold. This includes providing low-voltage electric power to low-voltage on-vehicle systems. The alternator emulating mode 220 may be activated when the SOC of the HV battery 25 is low, but not so low as to require charging. As described with reference to FIG. 3, and with continued reference to FIG. 1, the control system 10 transitions to operating the electric machine 35 in the alternator emulating mode 220 when the SOC is less than a fourth SOC threshold, wherein the fourth SOC threshold is determined based upon the vehicle speed. Operation in the alternator emulating mode 220 enables the vehicle 100 to behave like a conventional vehicle, i.e., a non-hybrid vehicle, at lower SOCs by providing a buffer between discharging and opportunity charging. This includes the ability to delay opportunity charging while maintaining sufficient electric power to service the electric load demand from the various elements of the auxiliary power system 45. The transition criteria between the states that delays the opportunity charging are a function of a target final SOC and vehicle speed. The levels of the target final SOC and the vehicle speed are based upon a predicted amount of regenerative electric power to be achieved from vehicle deceleration and regenerative braking associated with stopping the vehicle in order to assure that the SOC of the HV battery 25 is the same at the end of the trip segment as it was at the beginning of the trip segment, when the vehicle 100 is operating in a charge sustaining mode. Alternatively, the target final SOC of the HV battery 25 may be determined based upon a required SOC level to enable execution of the autostop/autostart operation during the next vehicle stop event.

FIG. 3, with continued reference to FIG. 1, schematically shows the state diagram 300 that is associated with selecting one of the powertrain operating modes associated with SOC control that are described with reference to FIG. 2, and in accordance with the concepts described herein. The power operating modes are categorized into engine fueling states, including the engine fueled state 305 and the engine FCO state 345. Operating the powertrain system 20 in the engine fueled state 305 includes operating in the opportunity charging mode 310, the alternator emulating mode 320, the ZMT mode 330, and the opportunity discharging mode 340. Operating the powertrain system in the engine FCO state 345 includes a stand-alone FCO state 350 and an FCO with regenerative braking state 360.

During operation in the opportunity charging mode 310, the powertrain system 20 is controlled to generate electric power in excess of that which is being consumed by the electrical loads of the vehicle 100, including the loads of the auxiliary power system 45. As such, there is a net increase in SOC of the HV battery 25. During operation in the alternator emulating mode 320, the powertrain system 20 is controlled to generate electric power to match the electric power demands of the vehicle 100, i.e., to match the loads of the auxiliary power system 45, and there is no net increase or net decrease in SOC of the HV battery 25. During operation in the ZMT mode 330, the powertrain system 20 is controlled with the electric machine 35 being decoupled from the internal combustion engine 40 or operating in the zero-motor torque mode, and there may be a net decrease in SOC of the HV battery 25 due to the loads of the auxiliary power system 45. During operation in the opportunity discharging mode 340, the powertrain system 20 is controlled with the electric machine 35 generating torque and consuming electric power from the HV battery 25. Thus, there is a net decrease in the SOC of the HV battery 25 due to torque generation.

Transitions between the various modes are commanded and executed based upon a magnitude of the SOC and SOC thresholds, wherein the SOC thresholds are determined in relation to the target final SOC and vehicle speed, with an allowance for hysteresis. As previously indicated, the target final SOC of the HV battery 25 is determined based upon having the SOC of the HV battery 25 be the same at the end of the trip segment as it was at the beginning of the trip segment when the vehicle 100 is operating in a charge sustaining state. Alternatively, the target final SOC of the HV battery 25 is selected to achieve an SOC level that is sufficient to enable execution of the autostop/autostart operation during the next vehicle stop event. The SOC level may be expressed as an absolute SOC, or as a delta SOC that is determined relative to a target SOC.

When the powertrain system 20 is operating in the opportunity discharging mode 340, it will command a transition to operate in the ZMT mode 330 when an output torque request is less than a first torque threshold (342). In a similar manner, when the powertrain system 20 is operating in the ZMT mode 330, it will command a transition to operate in the opportunity discharging mode 340 when the output torque request is greater than a second torque threshold (332), wherein the first torque threshold is less than the second torque threshold to provide hysteresis for the control system.

When the powertrain system 20 is operating in the ZMT mode 330, it will command a transition to operate in the alternator emulating mode 320 when the SOC is greater than a fourth SOC threshold (334). The fourth SOC threshold is determined in relation to speed and SOC. By way of a non-limiting example, the fourth SOC threshold may be SOC=30% at a vehicle speed of 100 km/hr, and SOC=40% at a vehicle speed of 30 km/hr. When the powertrain system 20 is operating in the alternator emulating mode 320, it will command a transition to operate in the ZMT mode 330 when the SOC is less than a second SOC threshold (322), wherein the fourth SOC threshold is less than the second SOC threshold to provide hysteresis for the control system. By way of a non-limiting example, the second SOC threshold may be SOC=35% at a vehicle speed of 100 km/hr, and SOC=45% at a vehicle speed of 30 km/hr.

When the powertrain system 20 is operating in the alternator emulating mode 320, it will command a transition to operate in the opportunity charging mode 310 when the SOC is greater than a first SOC threshold (324). By way of a non-limiting example, the third SOC threshold may be SOC=25% at a vehicle speed of 100 km/hr, and SOC=30% at a vehicle speed of 30 km/hr.

When the powertrain system 20 is operating in the opportunity charging mode 310, it will command a transition to operate in the alternator emulating mode 320 when the SOC is less than a third SOC threshold (312), wherein the third SOC threshold is less than the first SOC threshold to provide hysteresis for the control system. By way of a non-limiting example, the first SOC threshold may be SOC=20% at a vehicle speed of 100 km/hr, and SOC=30% at a vehicle speed of 30 km/hr. The first SOC threshold is selected based upon a predicted increase in SOC that is expected to be achieved during operation in the regenerative braking mode at the end of the trip segment, and is associated with a desired final SOC 432.

Transitions 307, 347 occur between the engine fueled state 305 and the engine FCO state 345 are shown, and are determined based upon the output torque request, with allowance for hysteresis.

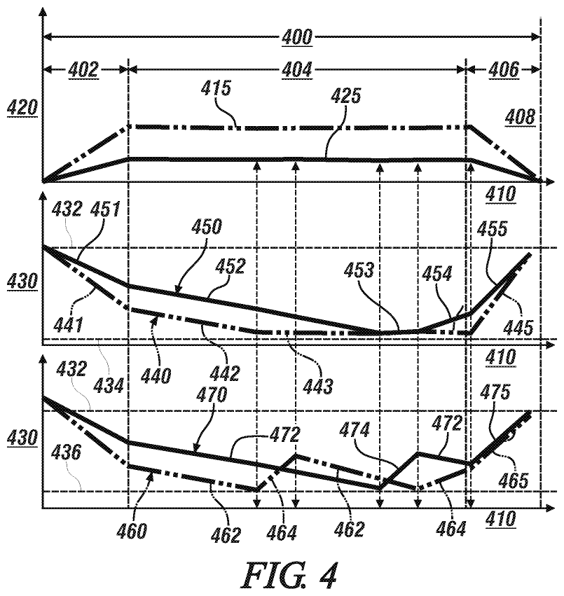

FIG. 4 graphically shows results associated with operation of an embodiment of the vehicle 100 including the powertrain system 20 described with reference to FIG. 1, including operating in accordance with the state diagram 300 associated with selecting one of the powertrain operating modes associated with SOC control that is described with reference to FIG. 3. The results show a single segment of a trip associated with vehicle operation 400, wherein the single segment includes an acceleration event 402, steady-state operation 404, and a deceleration event 406 leading to a vehicle stopping event 408. Plotted results include vehicle speed 420 and SOC 430 in relation to time 410, for a high speed operation 415 and a low speed operation 425. One control parameter associated with SOC control and operation of the powertrain system 20 is to have the desired final SOC, indicated by line 432, be the same at the end of the single segment of vehicle operation 400 as it was at the beginning of the single segment of vehicle operation 400 when operating in a charge sustaining mode. Alternatively, the control parameter associated with the SOC is to achieve a desired final SOC 432 that is greater than a minimum SOC threshold that is associated with executing autostop/autostart operation subsequent to the vehicle stopping event 408.

Line 440 depicts SOC and associated powertrain operating modes associated with the high speed operation during the acceleration event 402, steady-state operation 404, and the deceleration event 406 leading to the vehicle stopping event 408. Pertinent line segments include a first segment 441 associated with the opportunity discharging mode, a second segment 442 associated with the ZMT mode, a third segment 443 associated with the alternator emulating mode, and a fourth segment 445 associated with the regenerative braking mode. Line 440 indicates that operation in the alternator emulating mode is sufficient to maintain the SOC greater than the first SOC threshold, indicated by horizontal line 434, thus minimizing or avoiding operation in the opportunity charging mode. The first SOC threshold is analogous to the first SOC threshold that is described with reference to transition (324) of FIG. 3. The transitions between the powertrain operating modes are controlled by the associated torque or SOC thresholds, as described with reference to the state diagram 300 of FIG. 3.

Line 450 depicts SOC and associated powertrain operating modes associated with the low speed operation during the acceleration event 402, steady-state operation 404, and the deceleration event 406 leading to the vehicle stopping event 408. Pertinent line segments include a first segment 451 associated with the opportunity discharging mode, a second segment 452 associated with the ZMT mode, a third segment 453 associated with the alternator emulating mode, a fourth segment 454 associated with an opportunity charging mode, and a fifth segment 455 associated the regenerative braking mode. The transitions between the powertrain operating modes are controlled by the associated torque or SOC thresholds, as described with reference to the state diagram 300 of FIG. 3. Line 450 indicates that operation in the alternator emulating mode may result in some operation in the opportunity charging mode, as depicted with reference to the fourth segment 454, but such operation is minimized as compared to a system that has no alternator emulating mode.

For purposes of comparison, Line 460 depicts SOC and associated powertrain operating modes associated with high speed operation of an analogous system during the acceleration event 402, steady-state operation 404, and the deceleration event 406 leading to the vehicle stopping event 408, wherein the intent of the charging routine is to have the SOC be equal to or greater than the desired final SOC 432 subsequent to the vehicle stopping event 408. The powertrain modes include operating the powertrain system 20 in the opportunity charging mode, the ZMT mode, and the opportunity discharging mode, without benefit of operating in the alternator emulating mode. Horizontal line 436 indicates a minimum threshold that is associated with a minimum SOC that triggers operation in the opportunity charging mode. The minimum threshold associated with the minimum SOC is analogous to the first SOC threshold described herein. As shown, under this scenario the powertrain system 20 toggles between operating in the ZMT mode 462 and the opportunity charging mode 464 in order to maintain the SOC greater than the minimum threshold 436. The toggling between charging and discharging may lead to undesirable NVH issues.

Again, for purposes of comparison, line 470 depicts SOC and associated powertrain operating modes associated with low speed operation of an analogous system during the acceleration event 402, steady-state operation 404, and the deceleration event 406 leading to the vehicle stopping event 408, wherein the intent of the charging routine is to have the SOC be equal to or greater than the desired final SOC 432 subsequent to the vehicle stopping event 408. The powertrain modes include operating the powertrain system 20 in the opportunity charging mode, the ZMT mode, and the opportunity discharging mode, without benefit of operation in the alternator emulating mode. As shown, under this scenario the powertrain system 20 toggles between operating in the ZMT mode 472 and the opportunity charging mode 474 in order to maintain the SOC greater than the minimum threshold 436. The toggling between charging and discharging may lead to undesirable NVH issues.

The fifth segment 455 is associated the regenerative braking mode, which includes the deceleration event 406 leading to the vehicle stopping event 408, 465. During the fifth segment 455, there is an increase in the SOC under high speed operating conditions as indicated by line 460, and likewise there is an increase in the SOC under low speed operating conditions as indicated by line 470.

The concepts provided herein provide an SOC control strategy in the form of the alternator emulating mode for a vehicle equipped with a hybrid powertrain system that enables a delay in a transition into an opportunity charging mode at low levels of SOC, thus creating a buffer state that enables stabilization between the charging and discharging states. Such operation facilitates holding the SOC at a desired level while operating the hybrid powertrain system in response to operator torque requests, thus enabling discrete control of SOC. This includes employing hysteresis in the state transition criteria as a function of SOC and vehicle speed to prevent oscillation between the ZMT mode, the alternator emulating mode, and the opportunity charging mode to control the delay in using fuel to charge in anticipation of charging from regenerative braking during a subsequent deceleration event. At higher speeds where more regenerative braking energy is expected, the transition to the alternator emulating mode and opportunity charging mode are set to relatively lower SOC levels. At lower speeds, the transition to the alternator emulating mode and opportunity charging mode are set to relatively higher SOC levels.

In the alternator emulating mode 220, there is no intentional charging or discharging of the HV battery 25, which enables the vehicle 100 to behave like a non-hybrid vehicle at lower SOC states. The alternator emulating mode 220 provides a buffer between discharging and opportunity charging and enables a handle to control the delay of opportunity charging. The transition criteria between the states that delays the opportunity charging are a function of SOC and vehicle speed. This enables a handle to control to the predicted amount of the free energy that is captured by regenerative braking at deceleration before stopping the vehicle 100. At higher speeds where more regenerative energy is expected, the transition to operating in the alternator emulating mode 220 can be set to a lower SOC, and at lower speeds the transition criteria can be set to a higher SOC.

The terms “calibration”, “calibrated”, and related terms refer to a result or a process that compares an actual or standard measurement associated with a device or system with a perceived or observed measurement or a commanded position for the device or system. A calibration as described herein can be reduced to a storable parametric table, a plurality of executable equations or another suitable form that may be employed as part of a measurement or control routine. A parameter is defined as a measurable quantity that represents a physical property of a device or other element that is discernible using one or more sensors and/or a physical model. A parameter can have a discrete value, e.g., either “1” or “0”, or can be infinitely variable in value.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may generally be referred to herein as a “module” or “system.” Furthermore, the present disclosure may take the form of a computer program product embodied in a tangible medium of expression having computer-usable program code embodied in the medium.

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by dedicated-function hardware-based systems that perform the specified functions or acts, or combinations of dedicated-function hardware and computer instructions. These computer program instructions may also be stored in a computer-readable medium that can direct a computer or other programmable data processing apparatus to function in a particular manner, such that the instructions stored in the computer-readable medium produce an article of manufacture including instruction set that implements the function/act specified in the flowchart and/or block diagram block or blocks.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A method for operating a powertrain system for a vehicle, wherein the powertrain system includes an internal combustion engine coupled to an electric machine that is electrically connected to a DC power source, the method comprising:
dynamically monitoring vehicle speed and a state of charge (SOC) of the DC power source; and
transitioning to operating the electric machine in an alternator emulating mode when the SOC of the DC power source is less than a first SOC threshold;
wherein the first SOC threshold is determined based upon the vehicle speed; and
wherein the alternator emulating mode includes operating the electric machine in an electric power generating state to generate electric power to service an auxiliary power system.

2. The method of claim 1, wherein operating the electric machine in the alternator emulating mode comprises operating the electric machine in the electric power generating state, wherein operation in the electric power generating state is limited to generate electric power to service on-board accessory devices via the auxiliary power system.

3. The method of claim 1, wherein operating the electric machine in the alternator emulating mode further comprises operating the electric machine in the electric power generating state to generate sufficient electric power to service on-board accessory devices via the auxiliary power system and limited to avoid increasing the SOC of the DC power source.

4. The method of claim 1, wherein operating the electric machine in the alternator emulating mode comprises operating the electric machine in the electric power generating state to generate sufficient electric power to service the auxiliary power system to provide low-voltage electric power to low-voltage on-vehicle systems.

5. The method of claim 1, wherein the first SOC threshold is determined based upon the vehicle speed.

6. The method of claim 1, wherein the first SOC threshold is determined based upon the vehicle speed and a desired final SOC.

7. The method of claim 6, wherein the first SOC threshold is determined based upon a predicted increase in the SOC of the DC power source that is expected to be achieved during operation in a regenerative braking mode.

8. A powertrain system for a vehicle, comprising:
an internal combustion engine coupled to an electric machine that is electrically connected to a DC power source;
a controller, operatively connected to the internal combustion engine and the electric machine and in communication with the vehicle and the DC power source, the controller including an instruction set, the instruction set executable to:
dynamically monitor vehicle speed and a state of charge (SOC) of the DC power source; and
transition to operating the electric machine in an alternator emulating mode when the SOC is less than a first SOC threshold;
wherein the first SOC threshold is determined based upon the vehicle speed;
wherein the DC power source is electrically connected to an on-vehicle auxiliary power system; and
wherein the alternator emulating mode includes operating the electric machine in an electric power generating state to generate sufficient electric power to service the auxiliary power system.

9. The powertrain system of claim 8, wherein the instruction set executable to operate the electric machine in the alternator emulating mode comprises the instruction set executable to operate the electric machine in the electric power generating state, wherein operation in the electric power generating state is limited to generate electric power to service on-board accessory devices via the auxiliary power system.

10. The powertrain system of claim 8, wherein the instruction set executable to operate the electric machine in the alternator emulating mode comprises the instruction set executable to operate the electric machine in the electric power generating state to generate sufficient electric power to service on-board accessory devices via the auxiliary power system and limited to preclude an increase in the SOC of the DC power source.

11. The powertrain system of claim 8, wherein the instruction set executable to operate the electric machine in the alternator emulating mode comprises the instruction set executable to operate the electric machine in the electric power generating state to generate sufficient electric power to service the auxiliary power system to provide low-voltage electric power to low-voltage on-vehicle systems.

12. The powertrain system of claim 8, wherein the first SOC threshold is determined based upon the vehicle speed.

13. The powertrain system of claim 8, the first SOC threshold is determined based upon the vehicle speed and a desired final SOC.

14. The powertrain system of claim 8, wherein the first SOC threshold is determined based upon a predicted increase in SOC that is expected to be achieved during operation in a regenerative braking mode.

15. The powertrain system of claim 8, wherein the controller is arranged to control the internal combustion engine and the electric machine to manage the DC power source in a charge sustaining state.

16. Method for operating a powertrain system for a vehicle, wherein the powertrain system includes an internal combustion engine coupled to an electric machine that is electrically connected to a DC power source, and wherein the vehicle includes an auxiliary power system, the method comprising:
dynamically monitoring vehicle speed and a state of charge (SOC) of the DC power source; and
transitioning to operating the electric machine in an alternator emulating mode when the SOC of the DC power source is less than a first SOC threshold;
wherein the first SOC threshold is determined based upon the vehicle speed; and
wherein the alternator emulating mode includes operating the electric machine in an electric power generating state to generate a magnitude of electric power to service the auxiliary power system.

17. The method of claim 16, wherein operating the electric machine in the alternator emulating mode further comprises operating the electric machine in the electric power generating state to generate sufficient electric power to service on-board accessory devices via the auxiliary power system while maintaining the SOC of the DC power source at the first SOC threshold.

18. The method of claim 16, wherein operating the electric machine in the alternator emulating mode comprises operating the electric machine in the electric power generating state to generate sufficient electric power to service the auxiliary power system to provide low-voltage electric power to low-voltage on-vehicle systems.

19. The method of claim 16, wherein the first SOC threshold is determined based upon the vehicle speed and a desired final SOC.

20. The method of claim 19, wherein the first SOC threshold is determined based upon a predicted increase in the SOC of the DC power source that is expected to be achieved during operation in a regenerative braking mode.
